(19) United States
(12) Patent Application Publication
(10) Pub. No.: US 2020/0056598 A1
(43) Pub. Date: Feb. 20, 2020

(54) THERMAL HYDRAULIC PUMP

(71) Applicants: Miguel A. Timm, Sedona, AZ (US); Hans Swanger, Houston, TX (US)

(72) Inventors: Miguel A. Timm, Sedona, AZ (US); Hans Swanger, Houston, TX (US)

(73) Assignee: Axiom Technologies LLC, Houston, TX (US)

(21) Appl. No.: 16/104,808

(22) Filed: Aug. 17, 2018

(51) Int. Cl. F04B 17/00; F24D 11/00; F24S 40/55; F24S 10/90

(52) U.S. Cl. CPC F04B 17/006; F24S 10/90; F24S 40/55; F24D 11/003

(57) ABSTRACT

A thermal pump system energized by a daytime heating phase and a night time cooling phase associated with a naturally occurring environmental heating and cooling cycle includes a hydraulic fluid source, a thermal fluid expansion chamber having a fixed internal volume, and a hydraulic accumulator at least partially filled by a compressible gas. A first unidirectional flow valve connected to a first duct permits flow only out of the hydraulic fluid source during the night time cooling phase. A second unidirectional flow valve connected to a second duct permits flow only out of the thermal fluid expansion chamber upon expansion of the hydraulic fluid trapped in the thermal fluid expansion chamber due to heating during the daytime heating phase. The thermal fluid expansion chamber has a thermally conductive wall communicating thermal energy from the naturally occurring heating and cooling cycle to the hydraulic fluid trapped in the fixed internal volume.

### BACKGROUND OF THE DISCLOSURE

### 1. Field of Disclosure

The present disclosure relates to a devices and methods for pumping and storing pressurized hydraulic fluid.

### 2. The Related Art

Pressurized hydraulic fluid is often used for actuating mechanical devices such as actuated valves or flood gates that may be used as devices that operate infrequently in case of an emergency or special situation. Often these applications take place in remote locations where there is no electricity or other source of energy to provide the required hydraulic power.

There are in existence means available for driving hydraulic pumps in remote locations such as electromechanical hydraulic pumps powered by photovoltaic panels suitable for these applications but they bring much added complexity, costs and reduced reliability to the system and they are not practical for hydraulic systems that operates only occasionally.

The present disclosure addresses these and other drawbacks of the prior art.

### SUMMARY OF THE DISCLOSURE

In aspects, the present disclosure provides a thermal pump system energized by a daytime heating phase and a night time cooling phase associated with a naturally occurring environmental heating and cooling cycle. The system includes a hydraulic fluid source, a thermal fluid expansion chamber having a fixed internal volume, and a hydraulic accumulator at least partially filled by a compressible gas. The system also includes a first duct and a second duct. A first unidirectional flow valve connected to the first duct permits flow only out of the hydraulic fluid source during the night time cooling phase. A second unidirectional flow valve connected to the second duct permits flow only out of the thermal fluid expansion chamber upon expansion of the hydraulic fluid trapped in the thermal fluid expansion chamber due to heating during the daytime heating phase. The thermal fluid expansion chamber has a thermally conductive wall communicating thermal energy from the naturally occurring heating and cooling cycle to the hydraulic fluid trapped in the fixed internal volume.

In aspects, the present disclosure provides a related method for pressurizing hydraulic fluid by using a heating and cooling cycle naturally occurring in an environment. The method includes providing a source for the hydraulic fluid, a thermal fluid expansion chamber having a fixed internal volume, and a hydraulic accumulator. The source is connected via a first duct to the thermal fluid expansion chamber and a first unidirectional flow valve that permits flow only out of the source. The thermal fluid expansion chamber is connected via a second duct to the hydraulic accumulator and a second unidirectional valve that permits flow only out of the thermal fluid expansion chamber. The method further includes flowing the hydraulic fluid from the source to the thermal fluid expansion chamber during the cooling cycle; pressurizing the hydraulic fluid in the thermal fluid expansion chamber during the heating cycle and while the hydraulic fluid is trapped in the thermal fluid expansion chamber; and flowing the pressurizing hydraulic fluid via the second duct to the hydraulic accumulator.

The above-recited example of features of the disclosure have been summarized rather broadly in order that the detailed description thereof that follows may be better understood, and in order that the contributions to the art may be appreciated. There are, of course, additional features of the disclosure that will be described hereinafter and which will form the subject of the claims appended hereto.

### BRIEF DESCRIPTION OF THE DRAWINGS

For detailed understanding of the present disclosure, references should be made to the following detailed description of the preferred embodiment, taken in conjunction with the accompanying drawings listed below:

FIG. 1 illustrates one embodiment of a thermal hydraulic pump according to the present disclosure;

FIG. 2A illustrates an exemplary pressure in a hydraulic reservoir over time for a thermal hydraulic pump according to the present disclosure;

FIG. 2B illustrates pressure cycles in a thermal fluid expansion chamber over time for a thermal hydraulic pump according to the present disclosure;

FIG. 2C illustrates pressure build-up in an accumulator over time for a thermal hydraulic pump according to the present disclosure; and

FIG. 3 illustrates two thermal hydraulic pumps connected in series according to the present disclosure.

### DETAILED DESCRIPTION OF THE DISCLOSURE

Generally, the present disclosure is directed to a system that harnesses the energy captured in a hydraulic fluid that has expanded while being exposed to thermal energy. The system of the present disclosure has few, if any, external and internal moving parts. As discussed in greater detail below, the present disclosure provides thermal hydraulic pump assemblies that enable a naturally occurring daily cycle of heating and cooling to accumulate energy in the form pressurized hydraulic fluid. By “naturally occurring,” it is meant the heating and cooling that occurs without need of human intervention and principally due to forces of nature; e.g., winds, sunlight, humidity, etc.

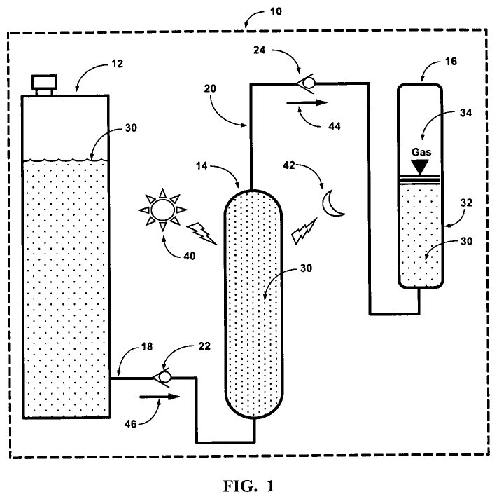

Referring to FIG. 1, there is shown one embodiment of a thermal hydraulic pump system 10 that may be used for supplying pressurized hydraulic fluid to operate a device. The system 10 includes a hydraulic reservoir 12 or equivalent source of hydraulic fluid 30, a thermal fluid expansion chamber 14, and a hydraulic accumulator 16. The thermal fluid expansion chamber 14 has a fixed interior volume. For simplicity, only one thermal fluid expansion chamber is shown. As needed for optimal performance, the thermal fluid expansion chamber can be constructed with a relatively high surface area in proportion to the trapped hydraulic volume for insuring the temperature in the hydraulic fluid 30 closely follows the day-night temperature variations. One non-limiting way this may be achieved is by connecting a number of smaller thermal fluid expansion chambers in parallel.

A first duct 18 and unidirectional valve 22 connects the reservoir 12 to the thermal fluid expansion chamber 14. A second duct 20 and unidirectional valve 24 connects the thermal fluid expansion chamber 14 to the accumulator 16. The unidirectional valves 22, 24 are configured to allow fluid flow into the thermal fluid expansion chamber 14 from the reservoir 12 and into the accumulator 16 from the thermal fluid expansion chamber 14, respectively. The system 10 uses a hydraulic fluid 30 having a coefficient of thermal fluid expansion that is large enough to induce a useable volumetric expansion when exposed to a naturally occurring thermal cycle. Suitable hydraulic fluids, include, but are not limited to almost all commercially available including oil base and water base hydraulic fluids.

The thermal fluid expansion chamber 14 is exposed to environmental changes in temperature. For example, during the day 40, solar radiation into the thermal fluid expansion chamber plus the increase in the ambient temperature surrounding the thermal fluid expansion chamber 14 causes the hydraulic fluid trapped in it to warm up and expand; thus, the thermal fluid expansion chamber 14 heats and expands the trapped hydraulic fluid using only a naturally occurring energy source, as opposed to human generated energy. The hydraulic fluid is trapped, i.e., able to flow only from the thermal fluid expansion chamber 14 into the accumulator 16 due to the unidirectional characteristics of the valves 22, 24 and by overcoming the pressure in the accumulator 16. At night time 42, the solar radiation has faded away and may decrease the surrounding ambient temperature. The thermal fluid expansion chamber 14 may have walls formed of thermally conductive materials that conduct the ambient heat into the hydraulic fluid 30 during the day 40 and allow thermal energy in the heated hydraulic fluid 30 to escape into the environment at night 42.

The hydraulic accumulator 16 may be selected from any of the commercially available in the market, rated to satisfy the volumes and pressures requirements for the expected application and typically include an interior 32 for receiving the hydraulic fluid 30 and a compressible gas 34. Suitable gases include, but are not limited to, nitrogen. The gas 34 is pressurized to a value that enables the hydraulic fluid 30 to be ejected at a specified range of pressures. The connection to the device to be actuated by the hydraulic pressure can be made via suitable duct or other flow passage known to those skilled in the art.

One illustrative mode of operation uses the naturally occurring twenty-four hour day-night thermal cycle to induce a daily expansion, or “warming up phase,” and a contraction, or “cooling down phase,” for the hydraulic fluid 30. In the morning, as the sun rises, the sun radiation as well as ambient temperature increase causes the temperature to increase in the hydraulic fluid 30 in the thermal fluid expansion chamber(s) 14. Due to the fixed interior volume of the thermal fluid expansion chamber 14, this expansion increases the pressure in the trapped hydraulic fluid 30, As the pressure in the thermal fluid expansion chamber 14 rises above the pressure in the accumulator 16, the hydraulic fluid 30 flows via the duct 20 from the thermal fluid expansion chamber 14 through the unidirectional valve 24 into the accumulator 16. The flow direction is shown with arrow 44. The hydraulic fluid 30 does not flow via the duct 18 into the reservoir 12 because the unidirectional valve 22 blocks such flow.

As the day ends, the ambient temperature and sun radiation falls and the hydraulic fluid 30 in the thermal fluid expansion chamber 14 contracts. Backflow from the accumulator 30 is prevented by the unidirectional valve 24. As the pressure in the thermal fluid expansion chamber 14 drops below the pressure in the reservoir 12, the hydraulic fluid 30 flows via the duct 18 from the reservoir 30 through the unidirectional valve 22 into the thermal fluid expansion chamber 14 and replaces the volume of hydraulic fluid 30 ejected to the accumulator 16 during the “warming up” daytime phase. At this point the pressure in the thermal fluid expansion chamber falls slightly below atmospheric pressure as a small pressure differential may be needed for the directional flow valve 22 to allow the flow from the reservoir 12 to the thermal fluid expansion chamber 14. The flow direction is shown with arrow 46. The cycle is repeated the next day. It should be noted that the energy from the cyclical expansion and contraction of the hydraulic fluid 30 in the thermal fluid expansion chamber 14 is stored as pressure in the gas 34 in the accumulator 16.

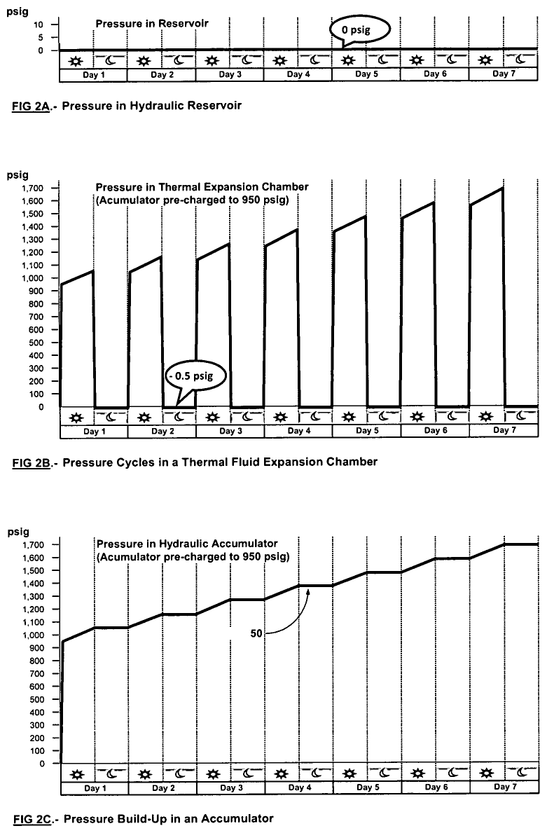

Referring to FIGS. 2A-C, there is graphically illustrated pressure in the reservoir 12, pressure cycles in the thermal fluid expansion chamber 14 (FIG. 1) and the pressure build up in the accumulator 16 (FIG. 1) over time. Time, in twenty-four hours increments (days), are shown along the “x” axis and pressures are shown along the “y” axis. The line 50 illustrates the incremental increase in pressure in the accumulator 16 over a number of days. While the daily increases are shown as the same, it should be understood that variations in temperature differentials will cause corresponding differences in daily pressure increases. Indeed, there may be some days wherein there is little or no pressure increase in the accumulator 16. In order to reach a desirable working volume and pressure, a number of cycles may be required. Thermal hydraulic pumps according to the present disclosure may be customized to the application. The desired daily volume can be obtained by, according to the expected daily temperature variations, sizing the total volume of the thermal fluid expansion chamber(s). The number of operations to be executed without having to wait for the thermal hydraulic pump to replace the spent hydraulic fluid can be obtained by selecting an accumulator with enough capacity to provide the desired number actions before depleting the accumulated hydraulic fluid.

Several factors that determine the volume pumped on each cycle are discussed below.

Temperature differential of each cycle, which depends mainly on the geographical area, is one factor. Thermal hydraulic pumps installed in interior lands and high solar radiations and cold nights are expected to show the best flow performance.

The thermal expansion of the hydraulic fluid 30 and is to be considered in conjunction with the other characteristics desired on a hydraulic system such as lubricity and chemical stability. Commercially available oil based hydraulic fluids have a thermal expansion coefficient of around 0.0004/° F. to 0.0005/° F. while water glycol hydraulic fluids have a thermal expansion coefficient of around 0.00034/° F.,

The volume of hydraulic fluid 30 trapped in the thermal fluid expansion chamber 14 is another main factor. This can be taken on account by increasing or decreasing the total volume of the thermal fluid expansion chamber 14 or designing the system with multiple standard size thermal fluid expansion chambers for achieving the desired total volume. The flow volume may be enhanced by providing means to maximize the sun radiation effect by shielding the thermal fluid expansion chamber 14 from the cooling effects of the natural breeze, i.e. providing an optically transparent shield that would allow the sun's radiation reach the thermal fluid expansion chamber while limiting the air movement cooling it.

Other factors include the compressibility of the fluid, volumetric thermal expansion and material elasticity of the chamber itself.

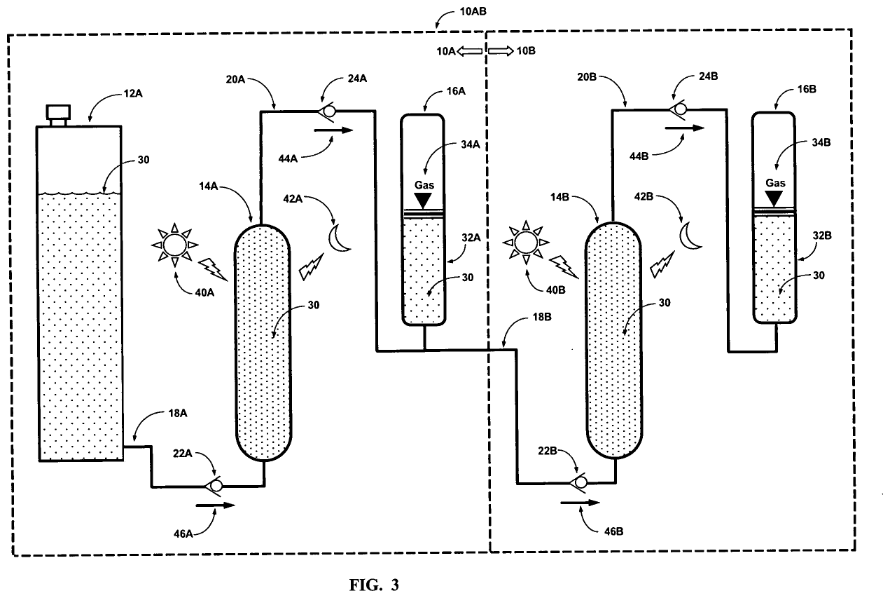

The FIG. 1 system 10 can accumulate pressures well above 3,000 psig in accordance with “real life” testing done on this design. If higher pressures are needed, a system 10AB may use two or more pump assemblies 10A, 10B connected in series as shown in FIG. 3. Each pump assembly 10A, 10B, includes a thermal fluid expansion chamber 14A, 14B and an accumulator 16A, 16B, respectively. A reservoir 12A supplies hydraulic fluid 30 via a duct 18A to the first pump assembly 10A. The duct 18A is controlled by a unidirectional valve 22A as discussed previously. The accumulator 16A supplies pressurized hydraulic fluid to the thermal fluid expansion chamber 14B via a duct 18B that is controlled by a unidirectional valve 22B. In this arrangement, the second pump assembly 10B receives pressurized hydraulic fluid from the accumulator 16A of the first pump assembly 10A via a duct 18B. The duct 18B includes a unidirectional valve 22B that provides unidirectional flow into the thermal fluid expansion chamber 14B. The hydraulic fluid 30 in the thermal fluid expansion chamber 14B is pressurized to a still higher pressure value and sent to the accumulator 16B via a duct 20B that includes a unidirectional valve 24B. Thus, the pressure of the hydraulic fluid 30 in the accumulator 16B is greater than the pressure of the hydraulic fluid 30 in the accumulator 16A. The only pressure limitations of such configurations with multiple stages are basically determined by the pressure rating of the components.

Unless otherwise specified, terms such as “approximately,” “about,” “around,” or “substantially,” mean a variance of plus or minus ten percent. The foregoing description is directed to particular embodiments of the present disclosure for the purpose of illustration and explanation. It will be apparent, however, to one skilled in the art that many modifications and changes to the embodiment set forth above are possible without departing from the scope of the disclosure. Thus, it is intended that the following claims be interpreted to embrace all such modifications and changes.

We claim:

1. A thermal pump system energized by a heating and cooling cycle naturally occurring in an environment, the naturally occurring cycle comprising a daytime heating phase and a night time cooling phase, the system comprising:
a source of a hydraulic fluid;
a first duct connected to the source and having a first unidirectional flow valve permitting flow only out of the source;
a thermal fluid expansion chamber having a fixed internal volume and connected to the first duct, the thermal fluid expansion chamber having a thermally conductive wall communicating thermal energy from the naturally occurring heating and cooling cycle in the environment to the hydraulic fluid trapped in the fixed internal volume;
a second duct connected to the thermal fluid expansion chamber and having a second unidirectional flow valve permitting flow only out of the thermal fluid expansion chamber upon expansion of the hydraulic fluid trapped in the thermal fluid expansion chamber due to heating; and
an hydraulic accumulator connected to the second duct, the accumulator having an interior volume at least partially filled by a compressible gas.

2. A method for providing pressurized hydraulic fluid by using a heating and cooling cycle naturally occurring in an environment, the naturally occurring cycle comprising a daytime heating phase and a night time cooling phase, the method comprising:
providing a source for the hydraulic fluid, a thermal fluid expansion chamber having a fixed internal volume, and a hydraulic accumulator, wherein the source is connected via a first duct to the thermal fluid expansion chamber, the first duct having a first unidirectional flow valve permitting flow only out of the source; and wherein the thermal fluid expansion chamber is connected via a second duct to the hydraulic accumulator, the second duct having a second unidirectional flow valve permitting flow only out of the thermal fluid expansion chamber;
flowing the hydraulic fluid from the source to the thermal fluid expansion chamber during the cooling cycle;
pressurizing the hydraulic fluid in the thermal fluid expansion chamber during the heating cycle and while the hydraulic fluid is trapped in the thermal fluid expansion chamber; and
flowing the pressurizing hydraulic fluid via the second duct to the hydraulic accumulator.
